(19) United States
(12) Patent Application Publication
(10) Pub. No.: US 2024/0363259 A1
(43) Pub. Date: Oct. 31, 2024

(54) DEVICE FOR CALORIMETRIC DETERMINATION OF THE DECAY HEAT POWER OF FUEL ELEMENTS

(71) Applicant: Kernkraftwerk Gösgen-Däniken AG, Däniken (CH)

(72) Inventors: Rainer KAULBARSCH, Brugg (CH); Fabian JATUFF, Schinzach-Bad (CH); Stefano CARUSO, Koblenz (CH); Leo ORNOT, Oberentfelden (CH); Marcel RIEKER, Niedergösgen (CH); Davide PAPINI, Ennetbaden (CH)

(73) Assignee: Kernkraftwerk Gösgen-Däniken AG, Däniken (CH)

(21) Appl. No.: 18/681,816

(22) PCT Filed: Aug. 11, 2022
(86) PCT No.: PCT/EP2022/072500

§ 371 Date: Feb. 6, 2024

(30) Foreign Application Priority Data
Aug. 12, 2021 (EP) 21191047.6

(51) Int. Cl. G21C 17/06; G01K 17/08

(52) U.S. Cl. CPC G21C 17/06; G01K 17/08

(57) ABSTRACT

A device for the calorimetric determination of the decay heat power of fuel elements has a calorimeter container with a coolant inlet and a coolant outlet, a line system with a coolant removal line and a coolant supply line, a feed pump, a flow measuring device, a first temperature measuring device at the coolant inlet, a second temperature measuring device at the coolant outlet, and a closing cover.

### FIELD OF THE INVENTION

The invention relates to a device for calorimetric determination of the decay heat power of fuel elements.

### BACKGROUND OF THE INVENTION

In the operation of nuclear power plants, particular attention is paid to the handling of spent fuel elements. As soon as fuel elements have come to the end of their designated useful life in the reactor core, they are first transferred to a so-called spent fuel pool. The spent fuel elements must decay in the spent fuel pool for some time before they can be transferred to transport, intermediate storage or final storage containers. Decay is necessary because fuel elements continue to emit a large amount of heat and radiation—the so-called decay heat power—for some time when they are removed from the reactor core at the end of their useful life. The decay heat power occurs because, on completion of the nuclear fission reaction, the fuel elements generally still contain short-lived fission products, which continue to decompose radioactively and produce after-heat. This has the result that a large amount of heat is released at least initially, which prevents storage in an optimised compact arrangement in transport, intermediate storage or final storage containers.

It is therefore necessary to cool the spent fuel elements—optionally also actively—in a spent fuel pool for some time until the decay heat power has subsided sufficiently that they can be transferred to the mentioned transport, intermediate storage or final storage containers. Of course, it is desirable on the one hand to make the residence time in the spent fuel pool sufficiently long, but also on the other hand to avoid unnecessarily long storage in the spent fuel pool. This makes it necessary to determine the decay heat power, which is coupled with the radiation dose, of the spent fuel elements as precisely as possible. The decay heat power of a spent fuel element is generally calculated. In order to determine the calculation inaccuracies and to validate the calculation methods, empirical tests are necessary for measuring the decay heat power. By means of corresponding test arrangements, especially by the use of calorimeters, the margins become more exact and the calculation inaccuracies are determined.

The decay heat power must of course be measured while complying with the required safety measures, especially as regards the radioactivity released by spent fuel elements.

Although devices and methods proposed hitherto for measuring the decay heat power are workable in principle, they have disadvantages, such as, for example, a lack of accuracy, the use of problematic measuring methods, or a considerable expenditure.

The problem of the present invention is therefore to propose a device for calorimetric determination of the decay heat power of fuel elements which is improved compared to such devices known in the prior art.

A device according to claim 1 solves that problem.

### SUMMARY OF THE INVENTION

A device for calorimetric determination of the decay heat power of fuel elements is proposed, which has:
a calorimeter container for arrangement in a coolant pool, having a vertical calorimeter shaft for receiving a fuel element, having at least one coolant inlet for supplying coolant to the calorimeter shaft, and having at least one coolant outlet for removing coolant from the calorimeter shaft, wherein the calorimeter shaft has at an upper end an upper shaft opening for the introduction and removal of the fuel element into and from the calorimeter shaft;
a line system having at least one coolant removal line connected to the coolant outlet, and preferably a coolant supply line connected to the coolant inlet;
a feed pump, connected on the input side to the coolant removal line, for generating a flow of coolant, especially a defined flow of coolant, through the calorimeter shaft along the fuel element (between the coolant inlet and the coolant outlet) and for removing coolant from the calorimeter shaft via the coolant outlet and the coolant removal line;
a flow measuring device at the coolant outlet or in the coolant removal line for determining the amount of coolant removed from the calorimeter shaft during operation;
a first temperature measuring device at the coolant inlet or—where present—in the coolant supply line for determining the temperature of the coolant supplied to the calorimeter shaft during operation;
a second temperature measuring device at the coolant outlet or in the coolant removal line for determining the temperature of the coolant removed from the calorimeter shaft during operation; and
a closing cover for reversibly closing the upper shaft opening, wherein the closing cover is maintained in a sealing manner on the upper shaft opening during operation by the negative pressure relative to the environment that is generated in the calorimeter shaft by the feed pump.

Advantageously, the device proposed here allows better validation of the calculation methods as well as better determination of the calculation inaccuracies, especially in the case of the determination of the decay heat power of spent fuel elements by calculation, than was possible hitherto using prior-known devices. As a result, safety when handling spent fuel elements is thus improved.

The calorimeter container preferably has a substantially cylindrical form. In cross section perpendicular to the vertical, the calorimeter container, especially the calorimeter shaft, can have a round (circular) or rectangular, especially square, form. The vertical arrangement of the calorimeter shaft on the one hand facilitates loading and unloading of the fuel element to be tested. The loading devices for fuel elements which are usually already present in coolant pools (spent fuel pools) can advantageously be used for loading and unloading the calorimeter shaft. Furthermore, due to the vertical orientation of the calorimeter shaft, natural convection can advantageously be utilised to deliver heat to the coolant flowing through, which consequently rises in the calorimeter shaft. The accumulation of gas pockets or gas bubbles can also effectively be prevented in a simple manner by the vertical orientation of the calorimeter shaft. Such accumulations of gas could, for example, reduce to an unacceptable extent/prevent sufficient cooling for the dissipation of the decay heat, or could also adversely affect the measurement accuracy of the device for calorimetric determination. Removal and loading through the upper shaft opening at the upper end of the calorimeter shaft are especially simple, especially when using the loading devices already mentioned.

The vertical calorimeter shaft advantageously has sufficient thermal insulation to the outside to achieve maximum measurement accuracy in that way. In particular, a supply or dissipation of heat from or into (typically into) the ambient medium of the coolant pool (spent fuel pool) can thus generally be prevented to a sufficient extent. The calorimeter container can in principle be insulated in any desired manner. The insulation can especially have insulating materials, but additionally or alternatively it is a vacuum insulation.

It is further conceivable that additional coolant baffles are also provided inside the calorimeter container in order to optimise a flow of coolant in the calorimeter container that is optimised for the intended purpose. In a normal operating position/measuring position of the device, the flow of coolant through the calorimeter shaft generally takes place between the coolant inlet and the coolant outlet, especially from the coolant inlet to the coolant outlet. In particular, a uniform through-flow can thus be ensured, preferably without the formation of regions, especially in the region of the fuel element, through which there is no flow or a poor flow.

The proposed configuration and arrangement of the feed pump for generating the coolant flow, that is to say especially the fluidic connection thereof to the coolant removal line, is advantageous especially in that a slight relative negative pressure thus forms in the calorimeter container while the device is in operation. By means of the negative pressure relative to the environment (pressure in the coolant pool), the closing cover can be reversibly maintained on the upper shaft opening, so that in that region no coolant (or only minimal coolant) is able to flow in, which increases the measurement accuracy. At the same time, particularly safe operation is thus possible because, in the case of a decreased output or in the event of failure of the feed pump, the relative negative pressure in the calorimeter container breaks down and thus the closing cover is able to open automatically. This then allows a passive flow through the calorimeter shaft to take place as a result of thermally induced density differences (natural convection), as a result of which sufficient emergency cooling can generally be ensured. This is especially advantageous with regard to so-called fail-safe requirements.

At the start of a measurement, the closing cover for reversibly closing the upper shaft opening can be brought preferably by suitable means into its reversible closed position and must be maintained in that position until the feed pump connected to the coolant removal line has been switched on and the negative pressure necessary for holding the closing cover down has built up. It is also possible to bring the closing cover into its reversible closed position after the feed pump has been switched on. In principle, this can be carried out by means of a corresponding manual handling step by the operator, but it can also be effected in an at least partially automated manner by means of a closing cover closing device which brings the closing cover into its reversible closed position in a start-up phase of the proposed device. It should be noted, however, that the closing cover is not maintained or is not to be maintained permanently in its reversible closed position by such handling steps or closing devices. The cover is (or is to be) permanently maintained in its reversible closed position preferably exclusively by the relative negative pressure which is introduced into the system by the feed pump. “Permanently” in this context is especially at least the period of time which is required for the intended calorimetric measurements.

It is proposed especially that the mean density of the closing cover is less than 990 kg/m³. In that case, the mean density of the closing cover is sufficiently low that it opens automatically in order to generate a flow of coolant when the feed pump is switched off, is not functional or is not sufficiently functional. This applies especially with regard to the ambient medium which is typically used in the coolant pool (spent fuel pool) and/or the coolant which is typically used, namely water. For the sake of completeness it should be noted that the water may optionally be provided with suitable additives (e.g. boric acid), as are known in principle in the prior art, and/or water which has an elevated content of heavy water compared to naturally occurring water can be used.

The calorimetric determination of the decay heat power is carried out substantially by determining the increase in temperature of the coolant as it flows through the device (and in so doing also flows past the fuel element), the increase in temperature being set in relation to the flow rate of the coolant. This measuring principle is known as such in the prior art. The flow rate of the coolant can be determined by at least one flow measuring device at the coolant outlet and/or in the coolant removal line. Any flow meters known in the prior art can in principle be used here, such as, for example, Coriolis flow meters. Such (Coriolis) flow meters are commercially available and have been found to be suitable for the intended purpose. The increase in the temperature of the coolant as it passes through the device is determined by a temperature difference measurement using at least two temperature measuring devices, of which one is arranged at the coolant outlet or in the coolant removal line (or at the edge of the coolant removal line) and the other is arranged at the coolant inlet or—where present—in the coolant supply line (or at the edge of the coolant supply line). It should be noted that a certain thermal power is introduced into the coolant as a result of the mechanical power of the feed pump. Accordingly, it is advantageous if the thermal energy input into the coolant that is attributable thereto is taken into consideration in the subsequent calorimetric measurement or calculation. Since the feed pump connected to the coolant removal line is generally operated at a constant speed, a good accuracy determination is possible by a preceding exact calibration measurement. Suitable temperature measuring sensors are likewise in principle known as such in the prior art. The relative temperature difference between the two measuring points is here of particular importance, while the absolute temperature is of secondary importance. Accordingly, it is important that the temperature measuring devices in question preferably permit a particularly precise measurement of the temperature difference, the accuracy of which may optionally also be enhanced by prior calibration of the temperature measuring devices. Especially suitable temperature measuring devices are commercially available quartz crystal temperature measuring probes, which have been found to be particularly advantageous for the intended application.

In addition or alternatively, the measurement accuracy of the device can be increased by the provision of gamma radiation conversion means (for example a lead shielding) for converting gamma radiation into thermal energy. The gamma radiation conversion means are preferably so arranged in the calorimeter container that they are arranged adjacent to the fuel element that is received in the calorimeter shaft during operation or surround at least in some regions the fuel element that is received in the calorimeter shaft during operation. In this manner, the gamma decay heat power can also be determined by means of the proposed calorimetric measurement, which is an advantage.

It is further proposed that, in the device, the coolant outlet is arranged at the upper end of the calorimeter shaft below the upper shaft opening. This achieves a direction of flow through the calorimeter shaft in which potentially unstable density stratifications, which in turn could result in escalating measurement errors, can be avoided. This is because, in that configuration, the main direction of the natural convection flow of the coolant (heating by the decay heat power of the fuel elements) and the main direction of the flow induced by the feed pump coincide. The coolant outlet can here be implemented by lateral openings (for example having a round cross section, a slot-like cross section or any other cross section). A plurality of openings may optionally also be provided. It is also conceivable that the coolant outlet is implemented by lines or line segments of (partially) annular form.

It is further proposed that the at least one coolant inlet has at least one opening formed laterally in the calorimeter container and/or an opening formed in a base of the calorimeter shaft where applicable. Likewise, the coolant outlet can have at least one opening formed laterally in the calorimeter container. The coolant inlet and/or the coolant outlet can further have a hose flange or a hose attachment region which is in fluidic communication with the opening formed laterally in the calorimeter container or in the base of the calorimeter shaft. A plurality of such connections is also conceivable. The coolant inlet and/or the coolant outlet optionally also has at least one pipe manifold of at least partially annular form, in order to achieve a largely rotationally symmetrical infeed or extraction of coolant.

The device can especially be configured in such a manner that, for implementing the coolant outlet, the calorimeter shaft preferably has an outlet opening, especially an outlet port, at the upper end of the calorimeter shaft below the upper shaft opening. In this manner, a particularly large proportion of the total length of the calorimeter shaft can be used for the calorimetric measurement. Measurement errors can thus be reduced. Moreover, the length of the calorimeter container relative to the maximum length of the fuel elements to be received by the calorimeter container can be particularly short and compact. It is clear that such a smallest possible size of the device, especially of the calorimeter container, is an advantage for reasons of space but also for reasons of measurement accuracy—inter alia because of lower heat losses and a lower heat input.

It is further proposed that, for implementing the at least one coolant inlet, the calorimeter container, or the calorimeter shaft, is open at the bottom, that is to say has an open lower end or a lower opening at a lower end. In that case, the open lower end or the lower opening at the lower end as the coolant inlet. Such a configuration can be an advantage especially with regard to a so-called fail-safe design of the device. In the event of failure of the feed pump, if the relative negative pressure in the calorimeter container drops, which in turn has the result that the closing cover opens automatically, a passive, thermally induced convection flow can then develop in the calorimeter shaft. Sufficient (emergency) cooling can then generally be achieved to effectively prevent the fuel elements from overheating as a result of heat decay power. At least this can be the case for a certain period of time and/or for fuel elements that have already been stored intermediately and have partially decayed.

It is also conceivable to configure the device in such a manner that the calorimeter shaft has a closed base at a lower end. In this configuration, the coolant inlet—as described above—can have at least one opening which is preferably formed laterally in the calorimeter container. In particular, the device—especially in the case where the calorimeter shaft has a closed base at a lower end—can have at least one upper inlet opening, especially an upper inlet port, for implementing the at least one coolant inlet. The upper inlet opening, especially the upper inlet port, is preferably arranged below the coolant outlet. In addition or alternatively, the device can have at least one lower inlet opening, especially a lower inlet port, at a lower end of the calorimeter shaft, especially at the closed base. With such a structural design it is possible especially to supply temperature-controllable or temperature-controlled coolant. For example, the temperature of the coolant can have been increased or lowered relative to the remainder of the fluid in the coolant pool (spent fuel pool). By means of the preliminary temperature control, especially a further improved measurement accuracy is possible. Moreover, it may optionally also be possible to guide the coolant in a more specific manner, especially past a gamma radiation conversion means, for example, so that a calorimetric measurement of the decay heat power in respect of gamma radiation is also possible, or the measurement accuracy of such a measurement can be increased.

For example, the device can have a gamma radiation conversion means—for example a lead shielding—which is so arranged that it surrounds, especially encases, at least in some regions the fuel element received in the calorimeter shaft during operation. In this configuration, for implementing the at least one coolant inlet the device can have at least one upper inlet opening from which coolant is introduced into the calorimeter container at the top and is guided downwards in the direction towards the base of the calorimeter shaft on the outer side of the gamma radiation conversion means encasing the fuel element (but inside an outer shell of the calorimeter container). From there, the coolant can then flow upwards in the calorimeter shaft—along the fuel element—in the direction towards the coolant outlet on the inner side of or inside the gamma radiation conversion means. In so doing, the coolant absorbs the heat generated by the gamma radiation on the downward path on the outer side of the gamma radiation conversion means, and on the upward path inside the gamma radiation conversion means it absorbs the thermal power radiated directly by the fuel element. It is also conceivable that, for implementing the at least one coolant inlet, the device has at least one lower inlet opening, especially a lower inlet port, at a lower end of the calorimeter shaft, especially at the closed base, from where the coolant flows upwards along the fuel element in the direction towards the coolant outlet both along the outer side of the gamma radiation conversion means encasing the fuel element and inside the radiation conversion means, where it is then removed again via the calorimeter container. In this configuration too, both the heat generated by the gamma radiation and the thermal power radiated directly by the fuel element are absorbed by the coolant as it flows past.

As already stated above, it can further be provided to configure the device in such a manner that the calorimeter container, the coolant removal line—at least between the coolant outlet and the second temperature measuring device—and, where present, the coolant supply line—at least between the coolant inlet and the first temperature measuring device—are thermally insulated or have an insulation. With such a design, the measurement accuracy of the device can be increased significantly. In principle, any desired insulation means are possible, such as, for example, insulation means in the form of solid foam, foamed insulation means and the like. In addition or alternatively, a vacuum insulation can be provided. Although the additional or alternative use of a vacuum insulation generally gives rise to a higher expenditure (in respect of the device to be provided and also during operation thereof), such an increased expenditure can typically be justified by the increased measurement accuracy. In particular, it should be noted in this context that the coolant removal lines and the coolant supply lines generally have a comparatively long length and in addition a comparatively small cross section, so that the ratio of the surface area (via which heat can be absorbed or released) to the volume of coolant in the line in question (“heat reservoir”) is especially high. Accordingly, this can result in a substantial impairment of the measurement accuracy, which should usefully be addressed by suitable measures, such as especially the insulation measures proposed herein.

For implementing the vacuum insulation, it can be provided that the calorimeter container, the coolant removal line—at least between the coolant outlet and the second temperature measuring device—and, where present, the coolant supply line—at least between the coolant inlet and the first temperature measuring device—are of double-walled form with an inner wall and an outer wall surrounding the inner wall, wherein an evacuable intermediate space is formed between the inner wall and the outer wall. It is further proposed that the device has at least a first vacuum pump device for generating a vacuum in the evacuable intermediate space. In this manner, the vacuum can be brought into and/or maintained in a defined pressure range at least while measurements are being carried out. As a result, on the one hand an especially good insulating action is possible. On the other hand, it is also possible that any residual thermal energy input or thermal energy release into the lines in question or from the line in question can have a comparatively precisely specifiable magnitude. As a result, it is possible especially that corresponding corrections can be applied by calculation, so that the resulting measurement accuracy can be increased in a simple manner.

According to a further advantageous embodiment of the proposed device, the line system can further have a coolant recycling line, wherein an upstream end of the coolant recycling line is connected on the output side to the feed pump, and a downstream end of the coolant recycling line can be arranged in the coolant pool for the recycling of coolant. A closed circuit can thus be formed in a simple manner, especially in that coolant which is removed, for example, from a coolant pool (spent fuel pool) can be conveyed back into the coolant pool (spent fuel pool) again after it has been used for the calorimetric determination of the decay heat power. As a result, the amount of waste water that is formed or is to be processed can generally be reduced significantly. This is especially advantageous both from the point of view of the environment and from the point of view of economics.

According to a further advantageous embodiment, the proposed device can further have a coolant temperature regulation device for regulating the temperature of the coolant to be supplied to the calorimeter shaft. The coolant temperature regulation device can have a mixing container or a mixing section, which is connected to an upstream end of the coolant supply line, and, if required, a recirculation pump for recirculating coolant in the mixing container or in the mixing section. By preliminary regulation of the temperature of the coolant in that way, the measurement accuracy of the calorimetric measurement can generally be increased even further. In particular, by suitably regulating the temperature, the release of heat from the coolant, or the input of heat into the coolant, can effectively be reduced, which can have a correspondingly positive impact on the measurement accuracy.

It is further proposed that the line system can further have a coolant intake line, wherein a downstream end of the coolant intake line opens into the mixing container or the mixing section, and an upstream end of the coolant intake line can be arranged in the coolant pool for the suctioning of coolant. As a result of this measure too, the amount of waste water that is produced or is to be processed can be reduced, as has already been explained hereinbefore. Moreover, the technical outlay for a coolant temperature regulation device which may be present can be reduced or optionally even eliminated entirely by the proposed configuration.

It is further proposed that the coolant temperature regulation device has at least a first temperature control device for heating or cooling the coolant to be supplied to the calorimeter shaft. The first temperature control device is arranged in or around the coolant supply line in a portion between the mixing container or the mixing section and the first measuring device. Such a construction can also be found to be advantageous with regard to the achievable measurement accuracy of the calorimetric measurement.

It is further proposed in the case of the device that the coolant temperature regulation device has a second temperature control device for heating or cooling the coolant to be supplied to the calorimeter shaft, wherein the second temperature control device for heating or cooling is arranged in or around the coolant supply line in a portion between the first temperature control device for heating or cooling and the first temperature measuring device. In this manner, on the one hand the accuracy with which the temperature of the coolant is controlled can be increased. On the other hand, the temperature control devices can thus optionally also be of a less technically complex design, because the required temperature control step for each temperature control device can be made smaller. The split can be made symmetrically (into two substantially equal temperature control steps) or asymmetrically, for example in such a manner that the first temperature control device, when seen in the direction of flow, performs a large part of the intended temperature control, while the second temperature control device carries out a proportionately smaller temperature control step, but optionally with increased accuracy of the temperature control (especially compared to the first temperature control step).

It is further proposed that the device has a second vacuum pump device for filling the line system and—where present—the mixing container or the mixing section with coolant under negative pressure. Such a construction can make it easier to bring the device into an operating position/measuring position. Such a vacuum pump device can optionally also be used to refill a falling coolant level, which can occur, for example, as a result of prolonged measuring times.

It is further proposed that, in the proposed device, the second vacuum pump device for generating a negative pressure in the mixing container or the mixing section and in the line system connected thereto is connected directly to the mixing container or the mixing section. As a result, especially high control accuracy in respect of the fill level in the mixing container or mixing section, or especially rapid filling of the mixing container or mixing section, can be achieved.

It is further proposed that, in the device, the line system has a connecting line between the coolant removal line and the coolant supply line that can be shut off. By means of such a connecting line that can be shut off, especially filling of the device at the start of a measurement that is to be carried out can be facilitated or accelerated. The connecting line that can be shut off can optionally also be used to achieve a (partial) short circuit of the coolant circuit, whereby especially efficient calibration of the temperature measuring devices/temperature measuring sensors is made possible, for example. The ability to shut off the connecting line can be achieved, for example, by means of a suitable shut-off valve. The shut-off valve can either be adjusted manually or can be in the form of a controlled valve. A controlled valve which in addition can be adjusted manually (especially manual override) is of course also conceivable.

It is further proposed that the calorimeter container has a lead shielding surrounding the calorimeter shaft. Such a lead shielding can be used especially as a thermal gamma radiation conversion means, as already mentioned above. With such a construction it is possible especially that the decay heat power due to the development of gamma radiation can also take place with sufficient accuracy and/or to a sufficient degree.

It can further be provided that, for the passage of coolant, the calorimeter container has on the outer side of the lead shielding/gamma radiation conversion means a coolant channel which surrounds the lead shielding/gamma radiation conversion means and which forms at least part of a flow connection between the coolant inlet and the coolant outlet through the calorimeter container. The coolant channel can be formed, for example, by the intermediate space between the outer side of the lead shielding/gamma radiation conversion means and the inner side of an outer shell of the calorimeter container. In this configuration, the device—as already described above—can have especially an upper inlet opening which is preferably arranged below the coolant outlet. From the upper inlet opening, coolant can be introduced into the calorimeter container at the top and can be guided downwards through the coolant channel in the direction towards the (preferably closed) base of the calorimeter shaft on the outer side of the lead shielding/gamma radiation conversion means encasing the fuel element (but inside an outer shell of the calorimeter container). From there, the coolant can then flow upwards in the calorimeter shaft—along the fuel element—in the direction towards the coolant outlet on the inner side of or inside the lead shielding/gamma radiation conversion means. In this manner, the coolant can advantageously be conducted in such a manner that a thermal energy input from the lead casing/gamma radiation conversion means into the coolant that is as efficient as possible can take place, so that all aspects of the decay heat power of the fuel element to be measured can be taken into consideration within the scope of a measurement. As a result, the measurement accuracy of the proposed device can be increased even further.

### DESCRIPTION OF THE DRAWINGS

Further advantageous aspects of the invention will become apparent from the following description of exemplary embodiments of the invention with reference to the figures, in which:

FIG. 1 shows a diagrammatic, simplified circuit diagram of an exemplary embodiment of the device according to the invention for calorimetric determination of the decay heat power of fuel elements;

FIG. 2 shows a detail of the device shown in FIG. 1, in order to explain the measurement instrumentation;

FIG. 3 shows the device shown in FIG. 1 in an operating position;

FIG. 4 shows the device shown in FIG. 1 in a filling position;

FIG. 5 shows the device shown in FIG. 1 in an emptying position;

FIG. 6 shows, in a diagrammatic side view, an exemplary embodiment of a calorimeter container in a first possible connection position; and

FIG. 7 shows, in a diagrammatic side view, the exemplary embodiment of a calorimeter container shown in FIG. 6 in a second possible connection position.

### DETAILED EXEMPLARY EMBODIMENT

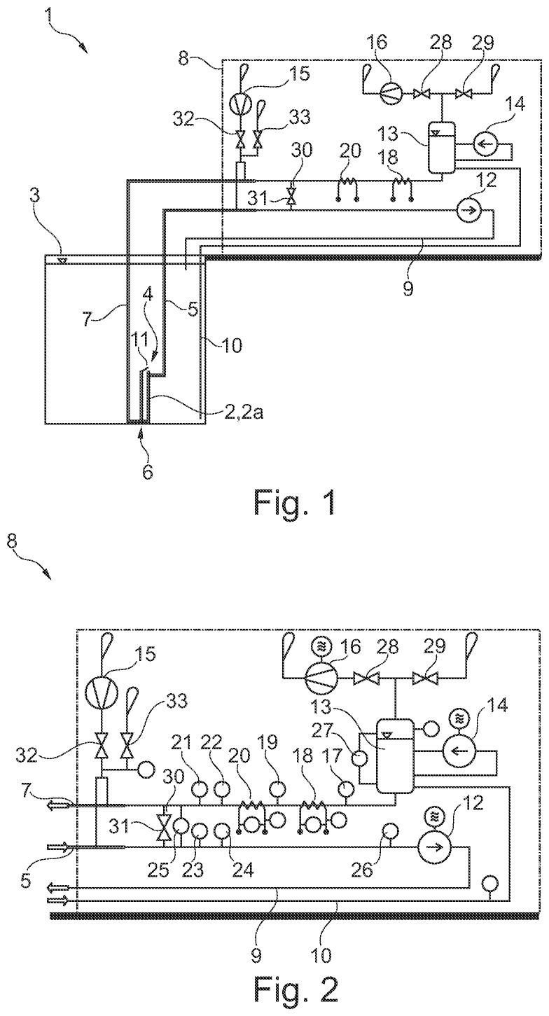

FIG. 1 shows, in simplified and diagrammatic form, the circuit diagram of an exemplary embodiment of the device 1 according to the invention for calorimetric determination of the decay heat power of fuel elements. The device 1 has a calorimeter container 2 having a vertical calorimeter shaft 2a, which has been placed in a coolant pool 3, for example a spent fuel pool or coolant pool of a wet storage facility for fuel elements, for the purpose of measuring the decay heat power of fuel elements (not shown) introduced into the calorimeter shaft 2a. The calorimeter container 2 preferably has a substantially cylindrical form. In cross section perpendicular to the vertical, the calorimeter container 2, especially the calorimeter shaft 2a, can have a round (circular) or rectangular, especially square, form. The calorimeter shaft 2a has at an upper end 37 an upper shaft opening for the introduction and removal of the fuel element into and from the calorimeter shaft 2a. The calorimeter shaft 2a additionally has a closing cover 11 which serves to reversibly close the upper shaft opening. The calorimeter container 2 is situated in the lower portion of a loading region of the coolant pool 3 at a sufficient depth that the distance between the upper end of the calorimeter shaft 2a and the water level of the coolant pool 3 is greater than the length of the fuel element to be measured, so that the fuel element is always covered completely with coolant when it is introduced into the calorimeter shaft 2a or removed from the calorimeter shaft 2a via the upper shaft opening. The distance between the upper end of the calorimeter shaft 2a and the water level of the coolant pool 3 can be, for example, 7 m.

The calorimeter container 2 is in fluidic communication with a measuring station unit 8 via a coolant removal line 5 and via a coolant supply line 7, the coolant removal line 5 being connected to a coolant outlet 4 at the upper end of the calorimeter shaft 2a and the coolant supply line 7 being connected to a coolant inlet 6 at the lower end of the calorimeter shaft 2a. A fluidic connection in the form of a coolant recycling line 9 and a coolant intake line 10 is further provided between the coolant pool 3 and the measuring station unit 8. As is apparent from FIG. 1, the measuring station unit 8 is arranged outside the coolant pool 3.

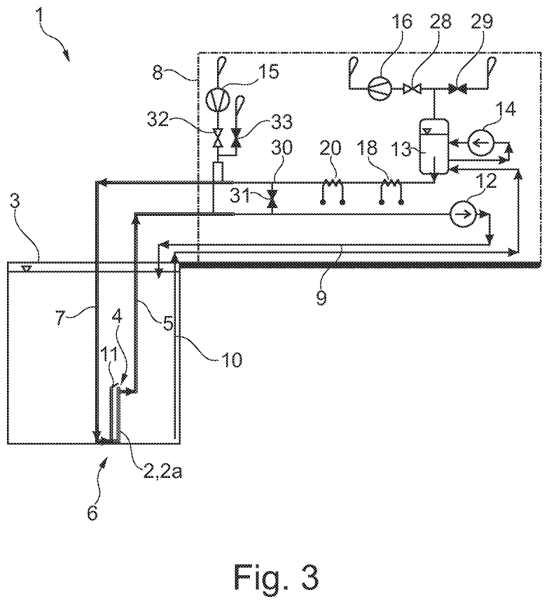

For reasons of clarity, the construction of the measuring station unit 8 is shown only partially in FIG. 1. Further details are depicted in FIG. 2. However, in the exemplary embodiment shown here of the device 1, the measuring station unit 8 shown in FIG. 1 has identical instrumentation and also otherwise the same construction as the measuring station unit 8 shown in FIG. 2. Moreover, the same also applies to the diagrammatic representations of the different operating states of the device 1 which are shown in FIGS. 3, 4 and 5.

In the present exemplary embodiment, the measuring station unit 8 has all the components which serve to convey the coolant used as the heat transfer medium and all the components necessary for measuring the decay heat power of the fuel elements. It is thus not necessary for sensors or other, electrically operated components to be arranged under water in the coolant pool 3. It can also be avoided that measuring devices/sensors are exposed to a high radiation dose.

The coolant serving as the heat transfer medium—here substantially water—is conveyed via a feed pump 12 in the form of a centrifugal pump. In the exemplary embodiment shown here, the feed pump 12 is equipped with speed control by a frequency converter. During operation, coolant is suctioned from the calorimeter shaft 2a by means of the feed pump 12 via the coolant removal line 5. The suctioned coolant is conveyed back into the coolant pool 3 on the output side of the feed pump 12 via the coolant recycling line 9.

During operation of the feed pump 12, a slight negative pressure develops in the calorimeter shaft 2a when the closing cover 11 is closed, which negative pressure maintains the closing cover 11 in its reversible closed position in the operating state of the device 1 (see also FIG. 3). Accordingly, the negative pressure generated in the calorimeter shaft 2a results in fluid being suctioned through the coolant supply line 7 into the calorimeter shaft 2a. The coolant supply line 7 in turn suctions the coolant from a mixing container 13 which is provided in the measuring station unit 8 and is filled to a designated filling level with coolant. The mixing container 13 acquires the coolant from the coolant container 3 via a coolant intake line 10.

A recirculation pump 14 is fluidically connected to the mixing container 13. The recirculation pump 14 serves to thoroughly mix the coolant in the mixing container 13, so that thermal stratification does not occur in the mixing container 13. In the exemplary embodiment shown here, the recirculation pump 14 is likewise in the form of a centrifugal pump and is provided with speed control by means of a frequency converter.

First and second vacuum pump devices 15, 16 are further provided in the measuring station unit 8. The first vacuum pump device 15 serves to evacuate an intermediate space between inner and outer walls of the calorimeter container 2 which are formed adjacent to one another and corresponding inner and outer walls of the coolant removal line 5 and coolant supply line 7 (each indicated by double lines in FIG. 1 to 5) which are of double-walled form in some regions. The vacuum so generated effects vacuum insulation of the calorimeter container 2 and of the double-walled region of the coolant removal line 5 and coolant supply line 7. As a result, a heat transfer between the coolant, which is situated in the coolant removal line 5, in the coolant supply line 7 and inside the calorimeter container 2, and the surrounding medium (coolant, here substantially water) in the coolant pool 3 is effectively reduced with high insulation quality. Advantageously, the accuracy of the calorimetric measurement can thus be significantly improved. It should be noted in this connection that the parts of the coolant removal line 5 and of the coolant supply line 7 that are situated outside the measuring station unit 8 are of a considerable length and in addition can potentially exhibit a high heat input or a high heat loss as a result of external contact with the liquid medium (water in the coolant pool 3). The same applies to the calorimeter container 2.

After a fuel element has been introduced into the calorimeter shaft 2a, the upper shaft opening is to be closed with the closing cover 11 at the start of a measurement. For that purpose, the closing cover 11 must be brought into its reversible closed position by means of a tool (not shown in detail here), before it is maintained in that reversible closed position as a result of the negative pressure induced by the feed pump 12. The closing cover 11 is configured in such a manner that it has a mean density of less than 990 kg/cm³. As a result, the cover has a lower density than the surrounding medium (water in the coolant pool 3). In the event of failure of the feed pump 12 (or if the feed pump is switched off), the closing cover 11 thus lifts automatically from its closing position at the upper shaft opening (the closing cover 11 floats up), so that the calorimeter shaft 2a opens towards the coolant pool 3. Automatic cooling of the fuel element in the calorimeter shaft 2a then takes place by means of natural convection, which is especially desirable from the fail-safe point of view.

The calorimetric determination of the decay heat power is carried out substantially by determining the increase in temperature of the coolant as it flows through the calorimeter container along the fuel element, the increase in temperature being set in relation to the flow rate of the coolant. This measuring principle is known as such in the prior art. The increase in temperature of the coolant is detected by means of a first temperature measuring device 21 at the coolant inlet 6 or in the coolant supply line 7 and by a second temperature measuring device 23 at the coolant outlet 4. The flow rate can be determined by at least one flow measuring device 24 at the coolant outlet 4 and/or in the coolant removal line 5.

For carrying out the actual calorimetric measurement, further measuring devices/sensors and devices are additionally provided in the measuring station unit 8. Thus, in order to increase the measurement accuracy of the device 1, temperature control devices 18, 20 for heating or cooling the coolant to be supplied to the calorimeter shaft 2a are provided, by means of which the temperature of the coolant can be (pre)controlled in a well defined manner before the coolant is supplied via the coolant supply line 7 to the calorimeter shaft 2a. The fundamental arrangement of these temperature control devices 18, 20 is shown in FIG. 1 and FIG. 2. The corresponding flow of coolant through the device 1 in the measuring position is additionally apparent from FIG. 3. The coolant removed from the mixing container 13 is first supplied to a first pre-run temperature measuring device 17. On the basis of the measured value of the first pre-run temperature measuring device 17 (and the target temperature value), the coolant is brought to a higher or lower temperature in a first temperature control device 18 by heating or cooling. The temperature of the coolant so heated or cooled is measured in a second pre-run temperature measuring device 19. On the basis of the second pre-run temperature measured value, further heating or cooling of the coolant is carried out in the second temperature control device 20. The temperature of the coolant is usually controlled in such a manner that a larger temperature control step takes place in the first temperature control device 18, while a smaller temperature control step takes place in the second temperature control device 20, but with greater accuracy of the temperature control. Although the procedure is generally such that the first temperature control device 18 and the second temperature control device 20 “control the temperature in the same direction”, that is to say either both heat or both cool, it is also entirely conceivable that temperature control takes place in different directions, that is to say, for example, in such a manner that the first temperature control device 18 cools the coolant while the second temperature control device 20 heats the coolant (or vice versa). Further measuring instruments (not shown here) can be used to check the functioning of the first temperature control device 18 and of the second temperature control device 20.

Before the coolant whose temperature has been controlled by the second temperature control device 20 is supplied to the actual coolant supply line 7, it is measured again, specifically on the one hand by means of a first temperature measuring device 21 in respect of its temperature and—as already mentioned above—by means of a first flow measuring device 22 in respect of its flow rate. It is possible to carry out first the temperature measurement and then the flow rate measurement or, as shown here, first the flow rate measurement and then the temperature measurement.

Furthermore, the coolant that flows back, after it has flowed via the coolant supply line 7, the calorimeter shaft 2a (where it is heated mainly by the decay heat power of the fuel element in the calorimeter shaft 2a) and the coolant removal line 5, is measured again by means of a second temperature measuring device 23 in respect of its temperature and by means of a second flow measuring device 24 in respect of its flow rate.

The increase in temperature of the coolant can be determined from the difference between the measured values of the first temperature measuring device 21 and the second temperature measuring device 23. The heat power, and thus the decay heat power of the fuel element in the calorimeter shaft 2a, can in turn be determined from the quotient of the temperature difference and the flow rate of the coolant.

The measured flow rate at the first flow measuring device 22 and at the second flow measuring device 24 should be equal. If the flow rates differ from one another, this is an indication that the calorimeter shaft 2a is not closed correctly by the closing cover 11 or that a leak has occurred elsewhere. In that case, the measurement is to be rated unreliable and is generally to be discarded.

A pressure difference measuring device 25 is further provided between the coolant removal line 5 and the coolant supply line 7. Hydraulic losses in the coolant lines 5, 7 and in the calorimeter shaft 2a can be determined by means of the pressure difference measuring device 25. The dissipation of the hydraulic losses initially appears as additional thermal energy, and the measured temperature difference between the first temperature measuring device 21 and the second temperature measuring device 23 is thus too high. By means of the pressure difference measuring device 25, this influencing factor can be corrected by calculation, and thus the measurement accuracy can be increased.

A pressure measuring sensor 26 is further provided just upstream, when seen in the direction of flow, of the feed pump 12, which pressure measuring sensor serves to monitor the intake pressure of the feed pump 12. A corresponding negative pressure signals that the closing cover 11 is seated correctly on the calorimeter shaft 2a.

In addition, the fill level of the coolant in the mixing container 13 is checked by means of a fill level measuring device 27. If the fill level falls, additional coolant can be suctioned from the coolant pool 3 into the mixing container 13 via the coolant intake line 10 by switching on the second vacuum pump device 16 and opening the intake valve 28. By contrast, if the fill level is too high, the fill level in the mixing container 13 can be lowered by opening the discharge valve 29 (connection to ambient pressure).

In the measuring position depicted in FIG. 3, the shut-off valve 31 in the connecting line 30 that can be shut off, which fluidically connects or separates the coolant removal line 5 and the coolant supply line 7 to or from one another, is closed (see also FIG. 3). Furthermore, in the measuring position (see also FIG. 3), the first vacuum pump device 15 is switched on and connected via the evacuation valve 32 to the evacuable intermediate spaces of the double walls of the coolant removal line 5, the coolant supply line 7 and the calorimeter shaft 2a, so that an insulating vacuum is generated there and is maintained.

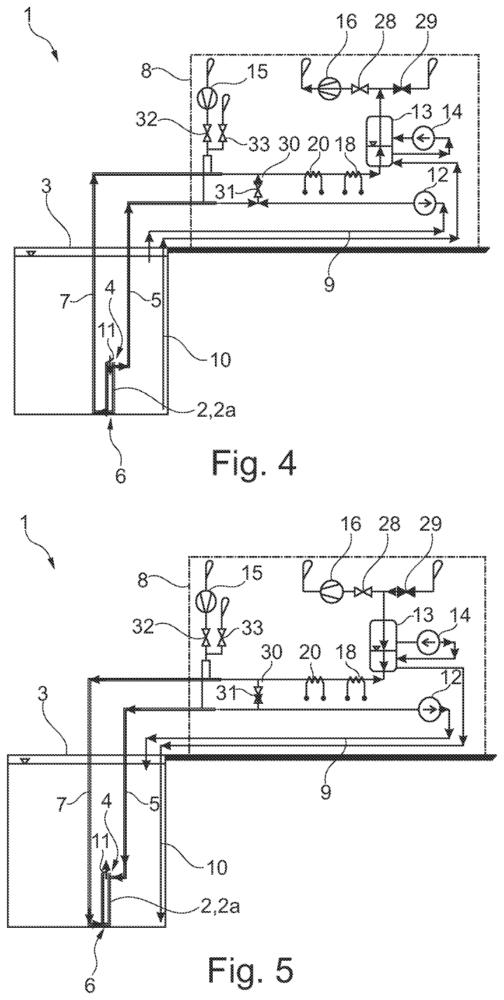

While FIG. 3 illustrates the measuring position as well as the directions of flow of the coolant that prevail in that position during measuring operation and the order in which flow takes place through the various measuring devices, temperature control devices and other devices in the measuring position, FIG. 4 shows, diagrammatically, the device 1 according to the invention in a filling position or filling mode. In the filling position, the first vacuum pump device 15 is switched on and the evacuation valve 32 is open, so that a thermally insulating vacuum can build up in the evacuable intermediate spaces of the coolant removal line 5, the coolant supply line 7 and the calorimeter shaft 2a.

Furthermore, the second vacuum pump device 16 is switched on and the intake valve 28 is open. As a result, the fill level in the mixing container 13, which initially is still empty, can be brought to the required height.

At the start of the filling mode, the closing cover 11 of the calorimeter shaft 2a is initially still open, the feed pump 12 is switched off, and the shut-off valve 31 of the connecting line 30 that can be shut off is open. As a result, the mixing container 13 fills with coolant via all the lines, that is to say via the coolant removal line 5, the coolant supply line 7, the coolant recycling line 9 and the coolant intake line 10. The lines in question are thus effectively vented. Furthermore, the recirculation pump 14 is switched on in order to recirculate the coolant already present in the mixing container 13 and avoid temperature gradients in the mixing container 13.

The changeover to measuring operation shown in FIG. 3 takes place by closing the closing cover 11 of the calorimeter shaft 2a, closing the shut-off valve 31 in the connecting line 30 that can be shut off, and switching on the feed pump 12. In addition, once a sufficient fill level in the mixing container 13 has been reached, the intake valve 28 is to be closed and the second vacuum pump device 16 is to be switched off.

The device is switched off, for example when measurement of the decay heat power of a fuel element is complete, in accordance with the diagram shown in FIG. 5. For that purpose, the first vacuum pump device 15 and the second vacuum pump device 16 are switched off, the evacuation valve 32 and the intake valve 18 are closed, and the venting valve 33, the discharge valve 29 and the shut-off valve 31 of the connecting line 30 that can be shut off are opened. In addition, the recirculation pump 14 and the feed pump 12 are switched off Consequently, the coolant runs back into the coolant pool 3 via all the lines, that is to say the coolant removal line 5, the coolant supply line 7, the coolant recycling line 9 and the coolant intake line 10. Because the feed pump 12 is switched off, the negative pressure in the calorimeter shaft 2a breaks down and the closing cover 11 opens automatically.

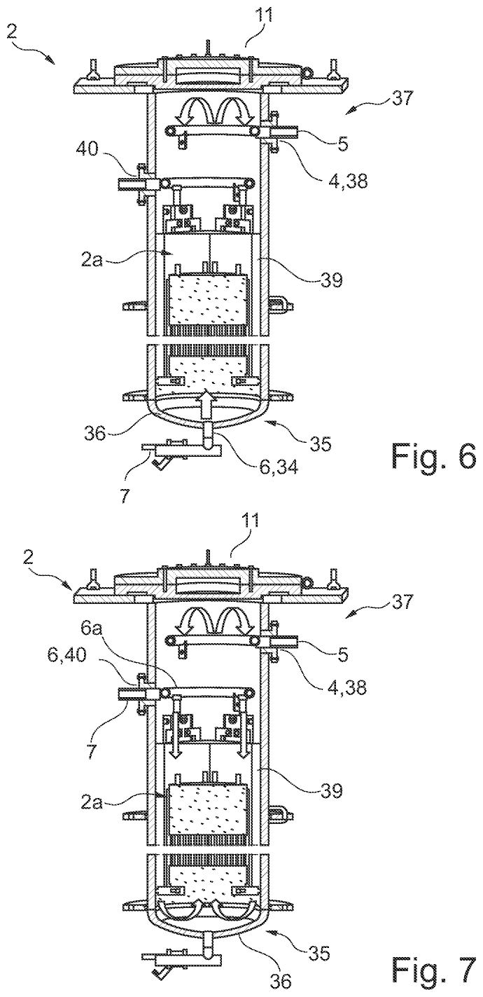

FIGS. 6 and 7 each show different variants of how coolant can flow through the calorimeter container 2 in a concrete exemplary embodiment of the device 1 according to the invention. In both variants, the closing cover 11 is in the closed position on the shaft opening of the calorimeter shaft 2a.

According to FIG. 6, coolant is supplied by means of the coolant supply line 7 via a lower inlet port 34 at the lower end 35 of the calorimeter container 2, which port forms a coolant inlet 6 through the base 36, which is otherwise closed, of the calorimeter shaft 2a. At the upper end 37 of the calorimeter shaft 2a there is provided an outlet port 38 serving as a coolant outlet 4 for removal of the coolant. As is shown in FIG. 6, the coolant outlet 4 additionally has a pipe manifold 4a of at least partially annular form, in order to achieve largely rotationally symmetrical extraction of the coolant.

There is further provided in the calorimeter shaft 2a a lead shielding 39 which surrounds the fuel element received in the calorimeter container 2 in the loaded state thereof and functions as a gamma radiation conversion means. In the present exemplary embodiment, the lead shielding 39 has a thickness of approximately 2 cm. As a result, a considerable proportion of the gamma radiation released by the fuel element is absorbed and converted into heat. During operation, the coolant introduced via the inlet port 34 at the lower end 35 of the calorimeter container 2 flows along the fuel element in the direction towards the pipe manifold 4a both along the outer side of the lead shielding 39 and inside the lead shielding 39, from where it is then removed from the calorimeter container 2 again via the outlet port 38. As a result, both the heat generated by the gamma radiation and the thermal power radiated directly by the fuel element are absorbed by the coolant as it flows past. Accordingly, the gamma decay heat power of the fuel element which is released is also incorporated into the calorimetric measurement of the device 1.

FIG. 7 shows an alternative variant of how the coolant can flow through the calorimeter shaft 2a. The coolant supplied by the coolant supply line 7 here flows into the calorimeter shaft 2a via an upper inlet port 40 serving as the coolant inlet 6. The upper inlet port 40 is arranged adjacent to the outlet port 38 but is displaced downwards relative thereto. Similarly to the coolant outlet 4, the coolant inlet 6 implemented by the upper inlet port 40 also has a pipe manifold 6a of at least partially annular form in order to achieve a largely rotationally symmetrical infeed of the coolant. As is indicated by the arrows, the coolant first flows from the upper intake port 40 or pipe manifold 6a downwards along the outer side of the lead shielding 39. At the lower end 35 of the calorimeter shaft 2a, the coolant is deflected by the closed base 36, from where it then flows upwards inside the lead shielding 39 along the fuel element in the direction towards the outlet port 38. The direction of flow of the coolant is so chosen that the downwardly directed flow path (from the upper inlet port 40 in the direction towards the closed base 36) and the upwardly directed flow path (from the lower base 36 in the direction towards the outlet port 38) are separated from one another by means of the lead shielding 39. In this variant too, both the heat generated by the gamma radiation and the thermal power radiated directly by the fuel element are absorbed by the coolant as it flows past. However, better heat dissipation of the lead shielding 39 can be achieved with the flow arrangement chosen in FIG. 7, and in this way the measurement accuracy can be increased.

Because the calorimeter container 2 according to FIG. 6 and FIG. 7 has both a lower inlet port 34 and an upper intake port 40, both the flow arrangements described above can advantageously be implemented with this calorimeter container 2.

1. A device for calorimetric determination of the decay heat power of fuel elements, having:
a calorimeter container for arrangement in a coolant pool, having a vertical calorimeter shaft for receiving a fuel element, having at least one coolant inlet for supplying coolant to the calorimeter shaft, and having at least one coolant outlet for removing coolant from the calorimeter shaft, wherein the calorimeter shaft has at an upper end an upper shaft opening for the introduction and removal of the fuel element into and from the calorimeter shaft;
a line system having at least one coolant removal line connected to the coolant outlet, and preferably a coolant supply line connected to the coolant inlet;
a feed pump, connected on the input side to the coolant removal line, for generating a flow of coolant through the calorimeter shaft along the fuel element and for removing coolant from the calorimeter shaft via the coolant outlet and the coolant removal line;
a flow measuring device at the coolant outlet or in the coolant removal line for determining the amount of coolant removed from the calorimeter shaft during operation;
a first temperature measuring device at the coolant inlet or—where present—in the coolant supply line for determining the temperature of the coolant supplied to the calorimeter shaft during operation;
a second temperature measuring device at the coolant outlet or in the coolant removal line for determining the temperature of the coolant removed from the calorimeter shaft during operation;
a closing cover for reversibly closing the upper shaft opening, wherein the closing cover is maintained in a sealing manner on the upper shaft opening during operation by the negative pressure relative to the environment that is generated in the calorimeter shaft by the feed pump.

2. The device according to claim 1, wherein the mean density of the closing cover is less than 990 kg/m³.

3. The device according to claim 1, wherein the coolant outlet is arranged at the upper end of the calorimeter shaft below the upper shaft opening.

4. The device according to claim 1, wherein, for implementing the coolant outlet, the calorimeter shaft preferably has an outlet opening, especially an outlet port, at the upper end of the calorimeter shaft below the upper shaft opening.

5. The device according to claim 1, wherein, for implementing the at least one coolant inlet, the calorimeter shaft is open at a lower end.

6. The device according to claim 1, wherein the calorimeter shaft has a closed base at a lower end and the calorimeter container, for implementing the at least one coolant inlet, has an upper inlet opening, especially an upper inlet port, at the upper end of the calorimeter shaft below the coolant outlet and/or a lower inlet opening, especially a lower inlet port, at a lower end of the calorimeter shaft, especially at the closed base.

7. The device according to claim 1, wherein the calorimeter container, the coolant removal line—at least between the coolant outlet and the second temperature measuring device—and, where present, the coolant supply line—at least between the coolant inlet and the first temperature measuring device—are thermally insulated, preferably by means of vacuum insulation.

8. The device according to claim 1, wherein the calorimeter container, the coolant removal line—at least between the coolant outlet and the second temperature measuring device—and, where present, the coolant supply line—at least between the coolant inlet and the first temperature measuring device—have an insulation or, for implementing the vacuum insulation, are of double-walled form with an inner wall and an outer wall surrounding the inner wall, wherein an evacuable intermediate space is formed between the inner wall and the outer wall.

9. The device according to claim 8, further having a first vacuum pump device for generating a vacuum in the evacuable intermediate space.

10. The device according to claim 1, wherein the line system further has a coolant recycling line, wherein an upstream end of the coolant recycling line is connected on the output side to the feed pump, and wherein a downstream end of the coolant recycling line can be arranged in the coolant pool for the recycling of coolant.

11. The device according to claim 1, further having a coolant temperature regulation device for regulating the temperature of the coolant to be supplied to the calorimeter shaft, wherein the coolant temperature regulation device has a mixing container or a mixing section, which is connected to an upstream end of the coolant supply line, and, if required, a recirculation pump for recirculating coolant in the mixing container or in the mixing section.

12. The device according to claim 11, wherein the line system further has a coolant intake line, wherein a downstream end of the coolant intake line opens into the mixing container or the mixing section, and wherein an upstream end of the coolant intake line can be arranged in the coolant pool for the suctioning of coolant.

13. The device according to either claim 11, wherein the coolant temperature regulation device has at least a first temperature control device for heating or cooling the coolant to be supplied to the calorimeter shaft, wherein the first temperature control device is arranged in or around the coolant supply line in a portion between the mixing container or the mixing section and the first temperature measuring device.

14. The device according to claim 13, wherein the coolant temperature regulation device has a second temperature control device for heating or cooling the coolant to be supplied to the calorimeter shaft, wherein the second temperature control device for heating or cooling is arranged in or around the coolant supply line in a portion between the first temperature control device for heating or cooling and the first temperature measuring device.

15. The device according to claim 1, further having a second vacuum pump device for filling the line system and—where present—the mixing container or the mixing section with coolant under negative pressure.

16. The device according to claim 15, wherein the second vacuum pump device for generating a negative pressure in the mixing container or the mixing section and in the line system connected thereto is connected directly to the mixing container or the mixing section.

17. The device according to claim 1, wherein the line system has a connecting line between the coolant removal line and the coolant supply line that can be shut off.

18. The device according to claim 1, wherein the calorimeter container has a lead shielding surrounding the calorimeter shaft, which lead shielding preferably serves as a gamma radiation conversion means.

19. The device according to claim 18, wherein the calorimeter container has on the outer side of the lead shielding, for the passage of coolant, a coolant channel surrounding the lead shielding, which coolant channel forms at least part of a flow connection between the coolant inlet and the coolant outlet.
